(19) United States
(12) Patent Application Publication
(10) Pub. No.: US 2024/0176893 A1
(43) Pub. Date: May 30, 2024

(54) BROWSER EXTENSION ANALYSIS

(71) Applicant: Royal Bank of Canada, Toronto (CA)

(72) Inventors: Axel Mierczuk, Toronto (CA); Udbhav Prasad, Toronto (CA); Adam Hulcoop, Whitby (CA); Felix Kurmish, Nepean (CA); Tom Wisniewski, Toronto (CA)

(21) Appl. No.: 18/523,584

(22) Filed: Nov. 29, 2023

Related U.S. Application Data
(60) Provisional application No. 63/429,006, filed on Nov. 30, 2022.

(51) Int. Cl. G06F 21/57; G06F 11/36

(52) U.S. Cl. CPC G06F 21/577; G06F 11/3604; G06F 2221/033

(57) ABSTRACT

Methods, systems, and techniques for analyzing a web browser extension are disclosed. A method of analyzing a web browser extension comprises: obtaining source code of the web browser extension; analyzing the source code to determine a risk posed by the web browser extension; and generating an indication of risk posed by the web browser extension based on the analysis of the source code.

### CROSS-REFERENCE TO RELATED APPLICATIONS

This application claims priority to U.S. Provisional Patent Application No. 63/429,006, filed on Nov. 30, 2022, the entire contents of which is incorporated herein by reference for all purposes.

### TECHNICAL FIELD

The present disclosure is directed at methods, systems, and techniques for analyzing risk posed by web browser extensions.

### BACKGROUND

Web browser extensions can execute code on webpages and thus represent an attack vector. Moreover, web browser extensions have access to large amounts of information within a web browser, and therefore present a high risk if that information is collected and/or used maliciously. There are no measures inherent in web browsers to detect malicious browser extensions, and in general, web browser extensions are either not risk-assessed at all or are manually evaluated. For organizations in particular, web browser extensions can pose a serious risk as employees can install web browser extensions easily and directly without oversight by the organization.

Accordingly, systems and methods that enable risk-analysis of web browser extensions remain highly desirable.

### SUMMARY

According to a first aspect of the present disclosure, there is provided a method of analyzing a web browser extension, comprising: obtaining source code of the web browser extension; analyzing the source code to determine a risk posed by the web browser extension; and generating an indication of risk posed by the web browser extension based on the analysis of the source code.

In some aspects, analyzing the source code of the web browser extension comprises: determining one or more permissions granted by the web browser extension; and assigning a risk category to each of the one or more permissions.

In some aspects, analyzing the source code of the web browser extension comprises analyzing the source code to identify one or more known risky behaviours.

In some aspects, the known risky behaviours comprise any one or more of: accessing a malicious webpage, making changes to a document object model, making browser application programming interface calls to gather information, making suspicious network requests, and making phishing requests.

In some aspects, analyzing the source code of the web browser extension comprises analyzing the source code to detect obfuscation in the source code.

In some aspects, analyzing the source code of the web browser extension comprises: extracting one or more URLs from the source code; and determining whether each of the one or more URLs are malicious by comparing each of the one or more URLs to known malicious webpages.

In some aspects, the method further comprises: determining whether each of the one or more URLs are associated with robotic network activity.

In some aspects, analyzing the source code of the web browser extension comprises generating a call graph from the source code and analyzing the call graph to identify suspicious behaviours.

In some aspects, analyzing the source code of the web browser extension comprises performing a dynamic analysis of the source code by running the web browser extension on a host machine to determine a behaviour of the web browser extension.

In some aspects, performing the dynamic analysis comprises executing user scenarios on the host machine while the web browser extension is running, and collecting test logs from one or more sources for analysis.

In some aspects, the method further comprises creating baseline logs by executing the user scenarios on the host machine without running the web browser extension, and wherein the test logs are compared to the baseline logs in the dynamic analysis.

In some aspects, obtaining the source code of the web browser extension comprises: receiving an identifier of the web browser extension; and obtaining the source code from a webstore page using the identifier of the web browser extension.

In some aspects, the method further comprises obtaining reputability information associated with the web browser extension, and wherein generating the indication of risk posed by the web browser extension is further based on the reputability information.

In some aspects, the reputability information associated with the web browser extension information is obtained from a webstore page for the web browser extension.

In some aspects, the method further comprises comparing the browser extension to a list of known malicious browser extensions, and wherein generating the indication of risk posed by the web browser extension is further based on the comparison.

In some aspects, the method further comprises storing results of the analysis of the source code of the web browser extension and the indication of risk posed by the web browser extension.

In some aspects, analyzing the source code of the web browser extension comprises performing a static analysis of the source code and performing a dynamic analysis of the source code by running the web browser extension on a host machine.

In accordance with another aspect of the present disclosure, a system is disclosed, comprising: a processor; and a non-transitory computer-readable medium having computer-executable instructions stored thereon, which when executed by the processor configure the system to: obtain source code of a web browser extension to be analyzed; analyze the source code to determine a risk posed by the web browser extension; and generate an indication of risk posed by the web browser extension based on the analysis of the source code.

In some aspects, the system is further configured to communicate with one or more user devices to determine web browser extensions operating thereon, and to determine the web browser extension to be analyzed from the web browser extensions operating on the one or more user devices.

In accordance with another aspect of the present disclosure, a non-transitory computer-readable medium is disclosed having computer-executable instructions stored thereon, which when executed by a processor configure the processor to perform a method of analyzing a web browser extension in accordance with any one of the above aspects.

This summary does not necessarily describe the entire scope of all aspects. Other aspects, features and advantages will be apparent to those of ordinary skill in the art upon review of the following description of specific embodiments.

### BRIEF DESCRIPTION OF THE DRAWINGS

In the accompanying drawings, which illustrate one or more example embodiments:

FIG. 1 depicts a computer network that comprises an example embodiment of a system for analyzing web browser extensions;

FIG. 2 is a block diagram of a server comprising part of the system depicted in FIG. 1;

FIG. 3 shows an overall method for analyzing web browser extensions;

FIG. 4 is a flow diagram showing an example method of identifying risky extensions;

FIG. 5 is a flow diagram showing an example of a method for analyzing web browser extensions;

FIGS. 6A and 6B show a further flow diagram of an example method for analyzing web browser extensions;

FIGS. 7A and 7B respectively show an example of a method and representation of an architecture for performing dynamic analysis of a web browser extension;

FIGS. 8A and 8B show an example architecture for analyzing web browser extensions;

FIGS. 9A-E show an example representation of scoring a risk posed by a web browser extension;

FIG. 10 shows a representation of using machine learning in the scoring algorithm;

FIG. 11 shows a representation of associating browser extensions with robotic activity;

FIG. 12 shows an exemplary method of analyzing a web browser extension; and

FIG. 13 shows an example graph of risk thresholds based on the indication of risk calculated from analysis of a web browser extension.

### DETAILED DESCRIPTION

Web browser extensions are often granted permissions of the device they are running on and are configured to execute various code, which a user of the device may not be aware of when using the web browser extension. Accordingly, such web browser extensions may pose a risk to the computing device and any user information.

Further, when employees of organizations use web browser extensions on their work computing devices, such web browser extensions can pose a risk to the organization as a whole. Organizations may not be aware of the web browser extensions being used by the employee devices, and even if web browser extensions in use are known, do not have a clear understanding of risk posed by the web browser extensions.

There is currently no simple technique to analyze web browser extensions and classify them as safe or risky, thus posing a major threat to user data/devices and to organizations. Manual techniques of attempting to evaluate known web browser extensions are time consuming and may be inconsistent.

In accordance with the present disclosure, methods, systems, and techniques for analyzing web browser extensions are disclosed. The methods, systems, and techniques for analyzing web browser extensions analyze various aspects of the web browser extension, and in particular analyze the source code of the web browser extension. An indication of risk posed by the web browser extension is generated that allows organizations/users to assess a risk posed by the web browser extension. Advantageously, the methods, systems, and techniques disclosed herein are able to provide an automated review and risk analysis of web browser extensions, and may for example be used for risk analysis of web browser extensions being used on user devices or being considered for use on user devices, such as within an organization, and thus provide useful information that may lead to preventing use of any web browser extensions determined to be risky.

In at least some embodiments herein, methods, systems, and techniques for analyzing a web browser extension are disclosed, comprising: obtaining source code of the web browser extension; analyzing the source code to determine a risk posed by the web browser extension; and generating an indication of risk posed by the web browser extension based on the analysis of the source code.

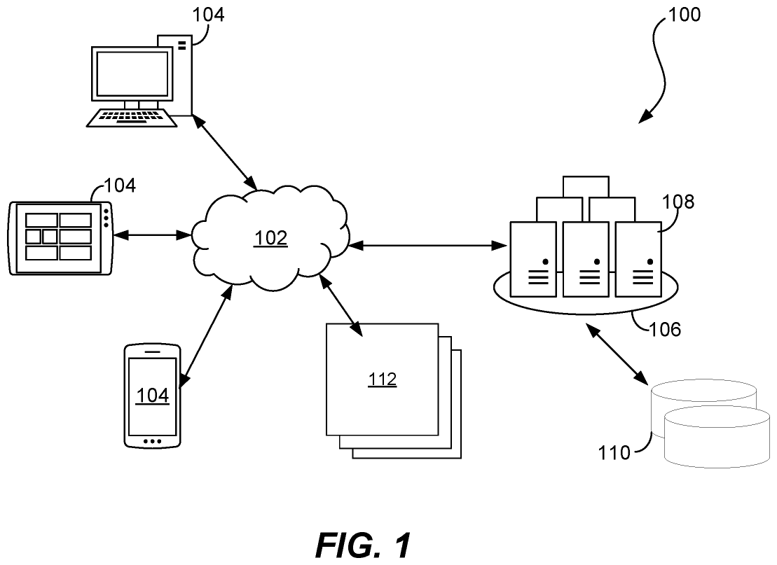

Referring now to FIG. 1, there is shown a computer network 100 that comprises an example embodiment of a system for analyzing web browser extensions. More particularly, the computer network 100 comprises a wide area network 102 such as the Internet to which various user devices 104 and data center 106 are communicatively coupled. The data center 106 comprises a number of servers 108 networked together to collectively perform various computing functions. The servers 108 may be distributed (cloud service). In accordance with the present disclosure, the number of servers 108 are configured to analyze web browser extensions being used or that may be used by the user devices 104. The number of servers 108 are configured to access one or more databases 110 storing relevant information used to analyze the web browser extensions, as well as one or more third party web pages 112, such as webstores for the web browser extensions and other third party applications. In some implementations, the user devices 104 may be used by various employees of an organization, and the servers 108 may belong to the same organization to analyze the web browser extensions. In this case the user devices 104 and the servers 108 may be connected over an Intranet for the organization. In other implementations, the user devices 104 may belong to a different organization than the servers 108, and/or may belong to more than one organization or no organization at all, and information on the web browser extensions being used by the user devices 104 may be sent to the servers 108 for analysis.

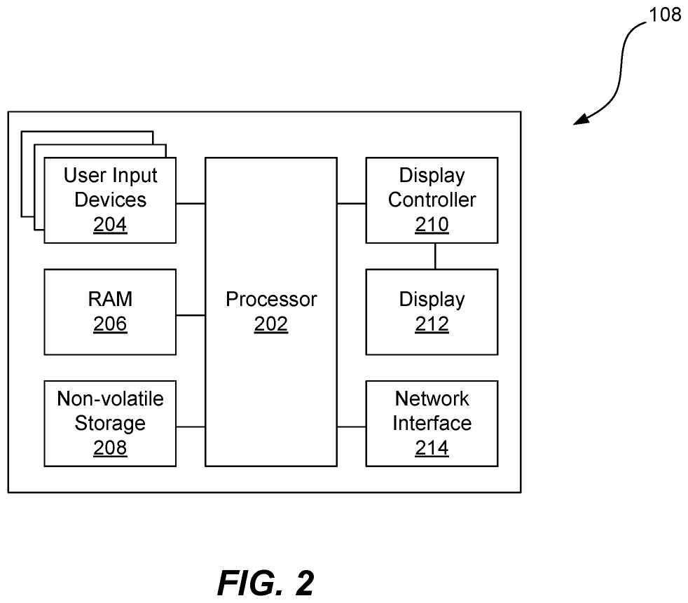

Referring now to FIG. 2, there is depicted an example embodiment of one of the servers 108 that comprises the data center 106. The server comprises a processor 202 that controls the server's overall operation. The processor 202 is communicatively coupled to and controls several subsystems. These subsystems comprise user input devices 204, which may comprise, for example, any one or more of a keyboard, mouse, touch screen, voice control; random access memory (“RAM”) 206, which stores computer program code for execution at runtime by the processor 202; non-volatile storage 208, which stores the computer program code executed by the RAM 206 at runtime; a display controller 210, which is communicatively coupled to and controls a display 212; and a network interface 214, which facilitates network communications with the network 102 and the other servers 108 in the data center 106. The non-volatile storage 208 has stored on it computer program code that is loaded into the RAM 206 at runtime and that is executable by the processor 202. When the computer program code is executed by the processor 202, the processor 202 causes the server 108 to implement a method for analyzing web browser extensions such as is described in more detail below. Additionally or alternatively, the servers 108 may collectively perform that method using distributed computing. While the system depicted in FIG. 2 is described specifically in respect of one of the servers 108, analogous versions of the system may also be used for the user devices 104.

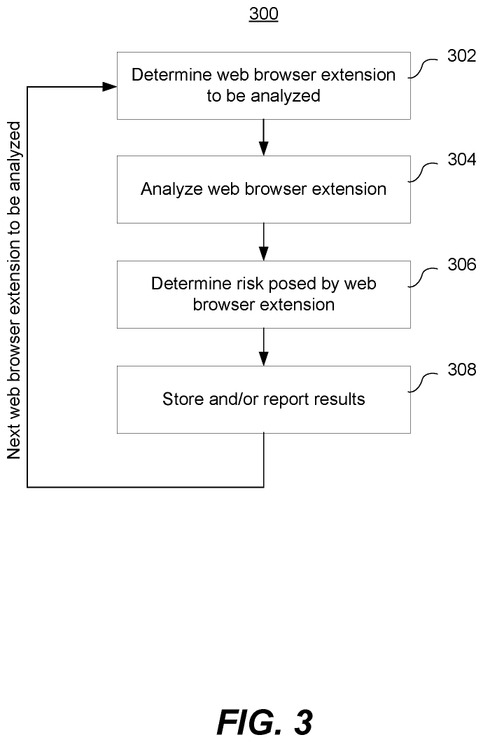

FIG. 3 shows an overall method 300 for analyzing web browser extensions. The method 300 may be performed at scheduled intervals or on-demand by the one or more servers 108 shown in FIG. 1, and may for example be stored as non-transitory computer-readable instructions for execution by a processor.

The method 300 comprises determining a web browser extension to be analyzed (302). In some embodiments, user devices may be queried to determine web browser extensions operating thereon. In other embodiments, an identifier of a web browser extension for analysis may be received. As noted above, the web browser extension to be analyzed may be determined at scheduled intervals (e.g. in batches of web browser extensions) or on-demand. When a web browser extension is identified, a database of previously analyzed web browser extensions may be accessed to determine if the web browser extension has already been analyzed. If the web browser extension has already been analyzed, there may be no need to perform the analysis again. However, web browser extensions may have been updated with new permissions, and according it may be determined that subsequent analysis of the web browser extension is required.

The web browser extension is analyzed (304). As described in more detail herein, analyzing the web browser extension comprises obtaining and analyzing source code of the web browser extension. The source code may be received (e.g. if the web-browser extension is a custom extension) or obtained using a web browser extension identifier (e.g. by accessing a webstore for the web browser extension). Analyzing the source may comprise performing a static analysis of the source code, e.g. to analyze permissions granted by the web browser extension, to identify risky behaviours of the web browser extension, to detect obfuscation in the source code, to extract and analyze URLs from the source code, to perform call graph analysis, etc., as described in more detail herein. Analyzing the web browser extension may additionally or alternatively comprise performing a dynamic analysis of the web browser extension by running the web browser extension in a controlled environment to determine a behaviour of the web browser extension. The analysis of the source code may be used to generate a risk score for the web browser extension.

An indication of risk posed by the web browser extension is determined (306) based on the analysis at 304. For example, the indication of risk may be generated based on a risk score calculated from the analysis of the source code. Further, one or more of a reputation score indicative of a reputability of the web browser extension and a maliciousness score indicative of a maliciousness of the web browser extension may also be determined and used for generating the indication of risk posed by the web browser extension. The results of the web browser extension analysis and indication of risk are stored and/or reported (308). Reports may be generated that summarize the web browser extension analysis and provide more insights into the analysis. Web browser extensions with an indication of risk that is indicative of a high risk posed by the web browser extension (e.g. greater than a threshold) may be flagged and an alert may be generated to appropriate stakeholders (e.g. users, security teams, etc.).

The method 300 proceeds to analyze a next web browser extension, which may be a new web browser extension that has not been previously analyzed, and/or an updated web browser extension that was previously analyzed and since updated.

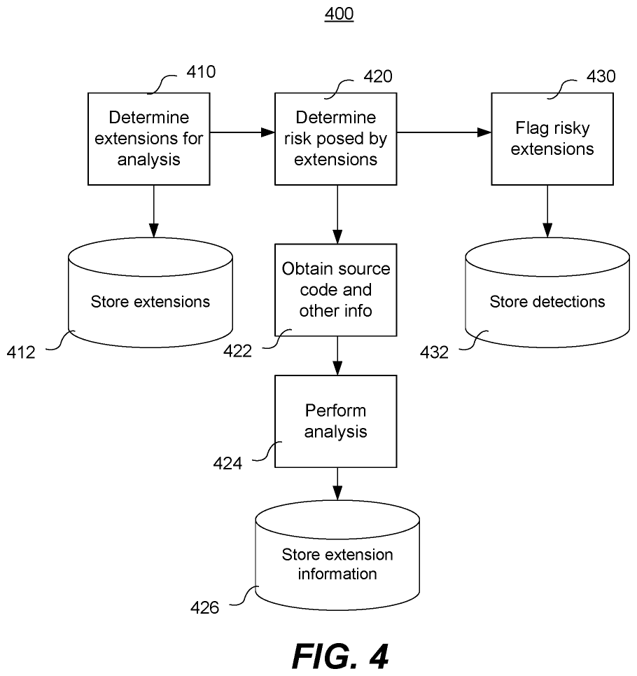

FIG. 4 is a flow diagram showing an example method 400 of identifying risky web browser extensions.

The method 400 comprises determining web browser extensions for analysis (410). For example, determining web browser extensions for analysis may comprise obtaining web browser extensions that are installed on user devices within an organization. As one example, the web browser extensions that are installed on the user devices may be obtained by querying an endpoint management tool such as Tanium, and retrieving the web browser extension locations and associated data, such as the browser type that the extension is installed on, the user ID and the host machine that installed the extension, the date that the extension was installed, the extension ID and version number, etc.. The web browser extensions and associated data are stored (412).

The method 400 comprises determining a risk posed by the web browser extension(s) (420). In some implementations, default web browser extensions (i.e. those provided by the organization on user devices), as well as extensions that have been previously analyzed, may be excluded from the determination/analysis. To determine if the web browser extension is risky, source code of the web browser extension is obtained, and other available information associated with the web browser extension may also be obtained (422). For example, the source code may be obtained directly from a device running the web browser extension, or downloaded from a webstore providing access to the web browser extension. Associated web browser extension information may be obtained from the webstore. The information from the webstore may be obtained by scraping information from the webstore page and/or by using APIs (e.g. Get requests) to extract information from the webstores (e.g. to return the manifest of the extension). The webstore page may be identified and accessed by using the extension identifier for the web browser extension. Using the information for the web browser extension, and in particular the source code as described in more detail below, web browser extension analysis is performed (424) to determine a risk posed by the web browser extension. The information on the web browser extension and the data generated from the analysis may be stored (426). Note that in some situations, such as for custom web browser extensions, there may not be a webstore page storing information on the web browser extension. In this case, the source code may be obtained to perform the analysis, but other information typically associated with browser extensions on webstore pages (e.g. description of the web browser extension, ratings, reviews, publisher information, etc.) may be unavailable.

As further described herein, based on the analysis of the web browser extension, an indication of a risk posed by the browser extension, such as an overall risk score, may be generated from the analysis of the web browser extension. Extensions that are deemed risky are flagged (430) and stored (432). In some implementations, the extensions deemed risky may be flagged for subsequent review by a security team, who may make the final decision of whether to block the extension on user devices.

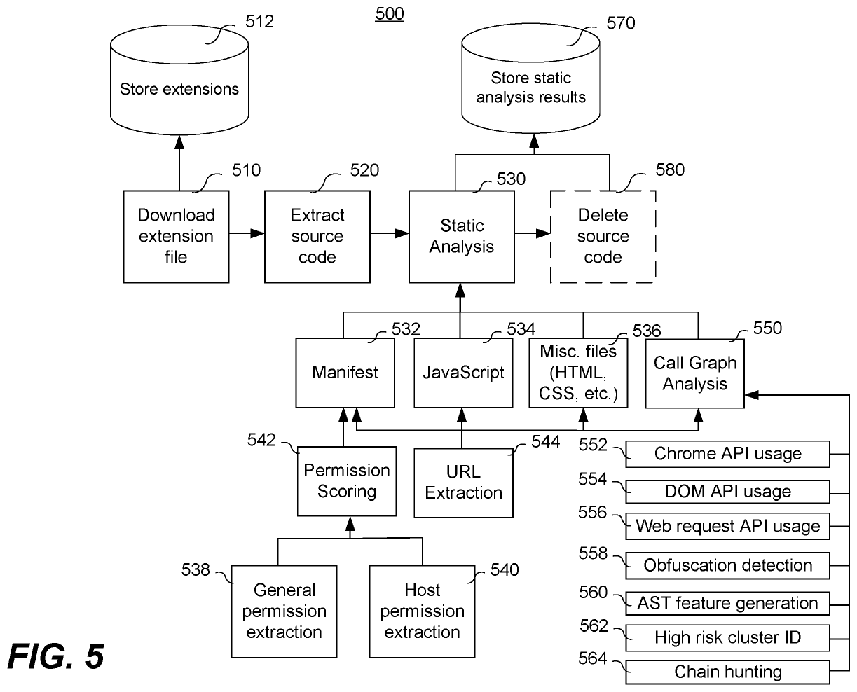

FIG. 5 is a flow diagram 500 showing an example of a method for analyzing web browser extensions. The method 500 may be performed as part of block 424 in FIG. 4.

The extension file for the web browser extension is downloaded (510), and information associated with the web browser extension is stored (512). In some implementations, the extension may be a custom extension or a locally/internally created extension that is not available from a webstore, and the extension file is downloaded directly from an internal source. In other implementations, the extension may be a third party extension and may thus be downloaded from a webstore. The web browser extension's source code is extracted (520).

A static analysis is performed on the source code (530). The static analysis may run in different modes depending on a type of the extension being analyzed. As an example, a lab mode may be used for analysis of locally/internally created extensions that are not available publicly on the webstore, i.e. the extension is provided by the internal development team for analysis; a custom mode may be used for analysis of custom extensions, where one would not want to call 3rd party APIs; and a normal mode may be used for analysis of other browser extensions, i.e. where the extension ID is provided and the extension can be downloaded from the webstore and analyzed.

Tasks involved with static analysis may include finding permissions (including host permissions) of the extension, identifying URLs as well as other relevant fields, etc., for use in evaluating a risk of the web browser extension. In an example, the extension file may be a Google Chrome extension, and the static analysis evaluates the manifest file (532), the JavaScript files (534), and miscellaneous files (e.g. HTML, cascading style sheets (CSS), etc.) (536) from the source code. The static analysis script comprises a manifest class used to interact with the manifest.json file for the web browser extension and extract relevant information, a JavaScript class used to interact with the JavaScript files and extract relevant information, and an HTML class used to interact with HTML files and extract relevant information, etc. It would be appreciated that the analysis can also be performed on source code written with other programming and markup languages, and that a similar approach could be taken with other browser/extension types that are not based on Chromium where analysis would be performed on extension configuration files, source code files, and other miscellaneous files from the source code.

As shown in FIG. 5, permissions are determined from the manifest file, including general permissions (538) and host permissions (540), and the permissions are scored (542) to determine a risk associated with the permissions. For example, a risk category may be assigned to each of the permissions, which may comprise accessing a database storing information comprising risk categories defined for each permission available to be granted by a given browser extension.

Further, URLs are extracted (544) using regular expressions from each of the manifest file (542), the JavaScript files (544), and the miscellaneous files (536), which can be evaluated to determine whether the URLs are malicious by comparing each of the one or more URLs to known malicious webpages, and/or to determine whether the URLs are associated with robotic network activity.

In addition, the static analysis (530) may comprise performing a call graph analysis (550). The call graph analysis generally comprises generating a call graph, parsing ASTs (Abstract Syntax Trees) and the call graph, analyzing the call graph, and optionally visualizing the call graph to present a clear picture of the source code. The call graph may for example be generated using a JavaScript program and parsed using Python. The AST (Abstract Syntax Tree) of JavaScript files is rich with information about what the web browser extension is doing, and is leveraged to generate a call graph, which is analyzed as part of the static analysis. For call graph generation, a customized package for web browser extension analysis was created. As an example, a call graph generator such as that of the Jelly project may be used as a starting point, modified to detect features particular to web browser extension analysis. For example, linting may be added to extract data that cannot be extracted directly from the call graph, such as to detect the usage of browser messaging modules, to detect the usage of Chrome specific built-in functions, to trace the re-assignment of the Chrome object in extensions, to detect the usage of Edge specific functions, to trace the re-assignment of the Edge object in extensions, to identify web extension listener instantiation, to detect fetch reassignment and fetch usage, to detect minified identifier names, to identify function re-assignment, to identify obfuscation using regex, to extract various other features from the AST, to identify webpackers, etc. Additional datapoints may also be extracted, and the AST may be modified for subsequent parsing as the call graph is generated. Further, if a function is identified in the call graph, various data may be extracted, such as function name, function parameters, control flow graph, cyclomatic complexity of the function, body features from basic blocks of the function, summary of features, etc. Further still, the call name and arguments may also be extracted. It will be appreciated that the above examples of data that may be extracted from the call graph is non-limiting.

The call graph is parsed to construct a clear view of the important aspects of the source code into a graph. A directional graph may be created for the analysis, which involves creating calls, creating functions, creating arguments, creating files, creating edges, creating elements, and creating data models. As shown in FIG. 5, call graph analysis (550) may involve determining Chrome API usage (552), document object model (DOM) API usage (554), web request API usage (556), obfuscation detection (558), identifying high risk clusters (562), and/or chain hunting (564). Cluster risk analysis is performed to determine how risky a cluster (e.g. a cluster of function calls) is in the source code. To find clusters, the directed call graph may be converted to an undirected call graph and the ilouvain algorithm may be used on the undirected call graph. Chain hunting is performed to identify suspicious chains of API calls, such as looking for chains of browser messaging calls, Chrome APIs, document calls, Edge API calls, fetch calls, listener calls, network calls, calls that are to an obfuscated function, etc., and scores them based on the severity of the calls.

It would also be appreciated that the static analysis may be configured to perform additional functionality than that shown in FIG. 5, such as detecting obfuscation of the source code, and/or implement other techniques for detecting risky activity that the source code may be trying to implement, for example making changes to DOM, making Browser API calls to gather certain information, making suspicious network requests, and/or making phishing requests. The source code may also be analyzed using various statistical analysis to make predictions of a risk posed by the browser extension, and may for example evaluate a number of dynamic code generation functions, a number of changes to DOM, a number of network requests, a number of iframe tags, and a number of form tags, which could be analyzed statistically in relationship with other benign or malicious web extensions. For example, a determination may be made as to whether the occurrence of iFrame tags in a web extension is statistically anomalous, and the determination may be applied to the risk score. Further, keyword density and other NLP analysis methods may be used for statistical analysis on the words/characters within a web extension (word/word grouping analysis, n-gram analysis, and more), and determining features that are relevant for risk scoring, and for implementation.

The information obtained from the static analysis (530) can be used to generate an overall score for the web browser extension indicative of a risk posed by the browser extension, as described in more detail below. The results from the static analysis are stored (570), and the source code may be deleted (580).

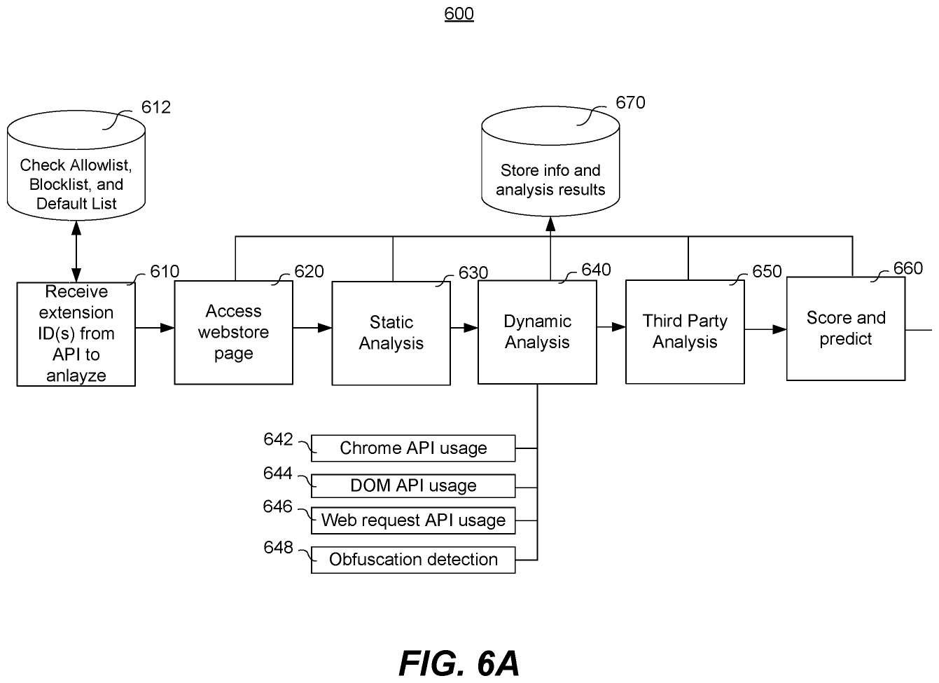

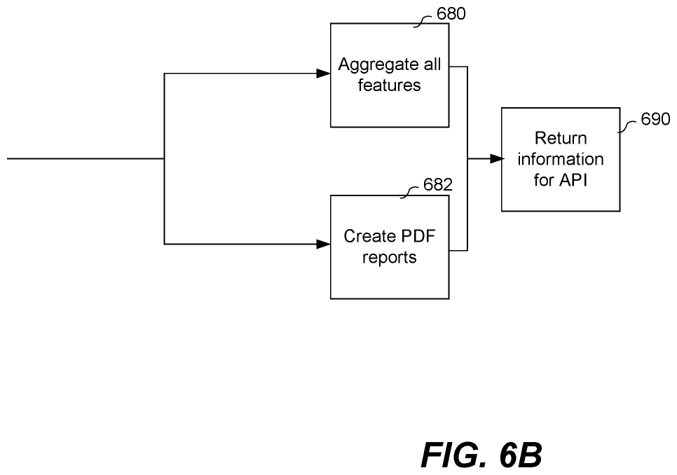

FIGS. 6A and 6B show a further flow diagram 600 showing an example of a method for analyzing web browser extensions. As seen in the flow diagram 600, the method includes the static analysis described in FIG. 5, and also performs a dynamic analysis of the source code at 640, and may also evaluate and use third-party information (if available) to generate an indication of risk for the web browser extension. It will be appreciated however that for locally/internally created browser extensions, some third-party information may be unavailable.

An indication of a web browser extension to be analyzed and its associated extension identifier is received (610). The indication of the web browser extension and/or its associated extension identifier may also include a current version of the web browser extension to be analyzed. A database storing lists of allowed, blocked, and default extensions is checked to confirm that the web browser extension (and corresponding version) has not already been analyzed (612).

The webstore page for the web browser extension is accessed to obtain relevant information regarding the extension (620), including but not limited to a title of the web browser extension, a listing URL, a description of the web browser extension, a popularity (e.g. number of users), reviews, rating, publisher information, extension file size, extension last update, and other miscellaneous information. The web browser extension information is stored in a database (670).

The source code is also obtained (e.g. from the webstore, or received separately), and a static analysis is performed (630), as described with reference to FIG. 5. The results from the static analysis may be stored (670).

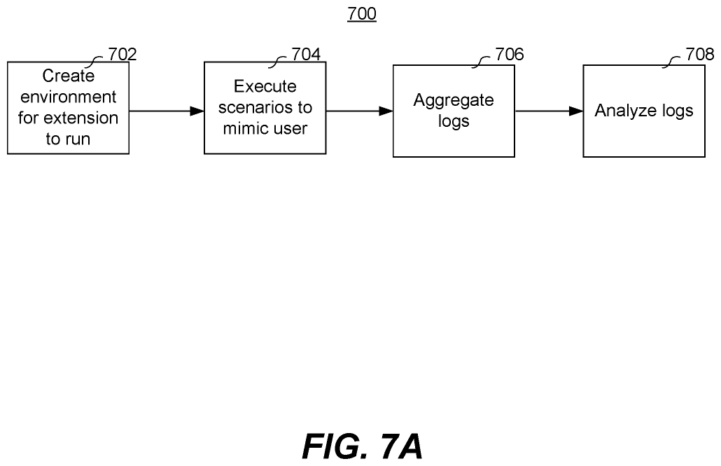

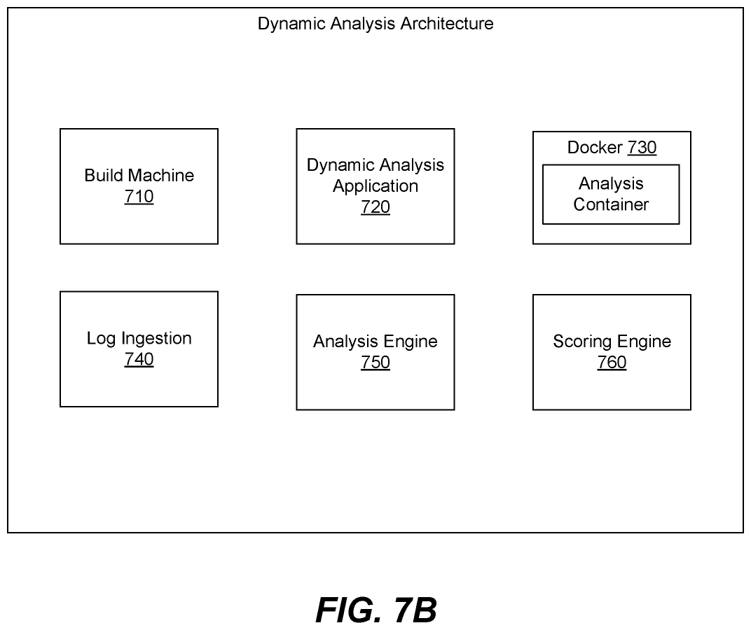

In the flow diagram 600, a dynamic analysis is also performed in addition to the static analysis. The dynamic analysis is performed by running the web browser extension on a host machine to determine a behaviour of the web browser extension. Details of the dynamic analysis are described with reference to FIGS. 7A and 7B below. As shown in the flow diagram 600, the dynamic analysis evaluates features of the behaviour of the web browser extension including Chrome API usage (642), DOM API usage (644), web request API usage (646), and/or obfuscation detection (648).

Third party analysis of the web browser extension may also be obtained (650). For example, CRXcavator and Chrome-Stats (or other browser extension statistics) may be accessed via APIs to obtain a third-party score and/or other information calculated for the web browser extension. For example, from CRXcavator the following data may be obtained: total_risk (total risk), webstore_risk (risk score of webstore listing), csp_risk (risk score of Content Security Policy (CSP)), permissions_risk (risk score of the permission of the extension), retire_risk (risk score from Retire JS results), dangerous_functions (dangerous functions in the extensions such as Chrome API), retire_js_results (Retire JS vulnerability scan results), entry_points (entrypoints of the extension), and related_extensions (list of related extensions). From Chrome-Stats, the following data may be obtained: user_count_score (score of the user count the extension has), rating_score (score of rating the extension has), review_score (score of reviews the extension has), size_score (score involving the extension size), update_time_score (score of how frequent the extension is updated), permissions_score (score of how many permissions the extension has (weighted)), risk_score (overall risk score of the extension), is_trusted_publisher (whether the publisher is trusted), is_chrome_featured (whether the extension is featured), is_privacy_collection_disclosed (whether the privacy collection is disclosed), extensionDeleted (whether the extension is deleted from the webstore), and bySameDev (list of extensions from the same developer).

Further, third party intelligence sources may be used to analyze URLs extracted from the web browser extension as part of third party analysis (650). For example, HYAS or Virustotal may be used to gather intelligence on related URLs extracted from the web browser extension during analysis, e.g. by querying these intelligence sources for information about domains and files extracted from the web browser extension. It would be appreciated that additional and/or different types of third party analysis could be obtained for use in analyzing the web browser extension.

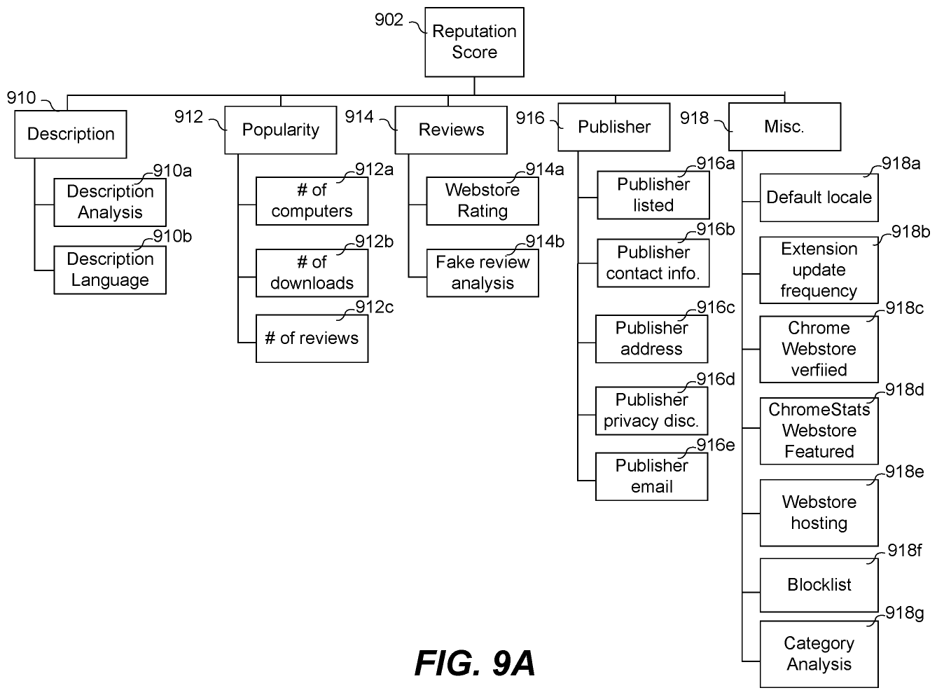

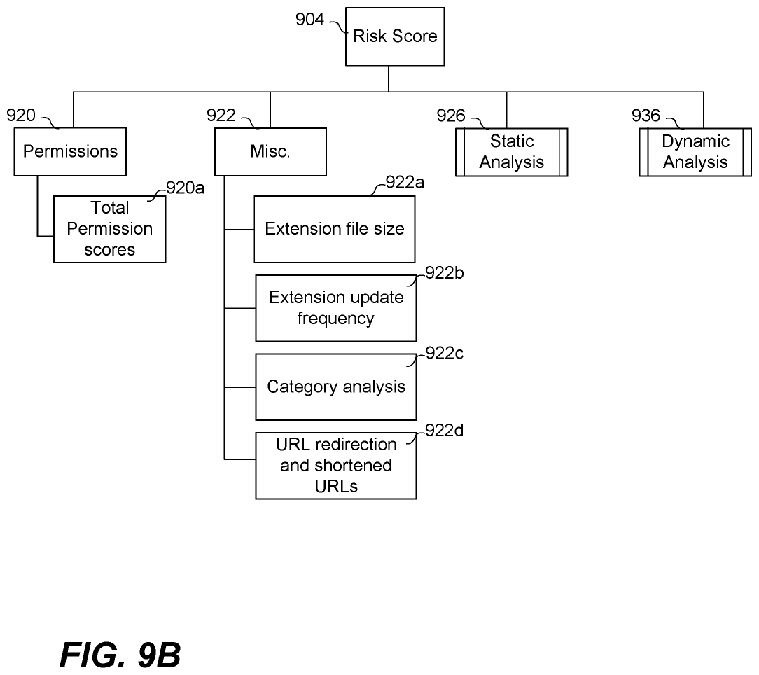

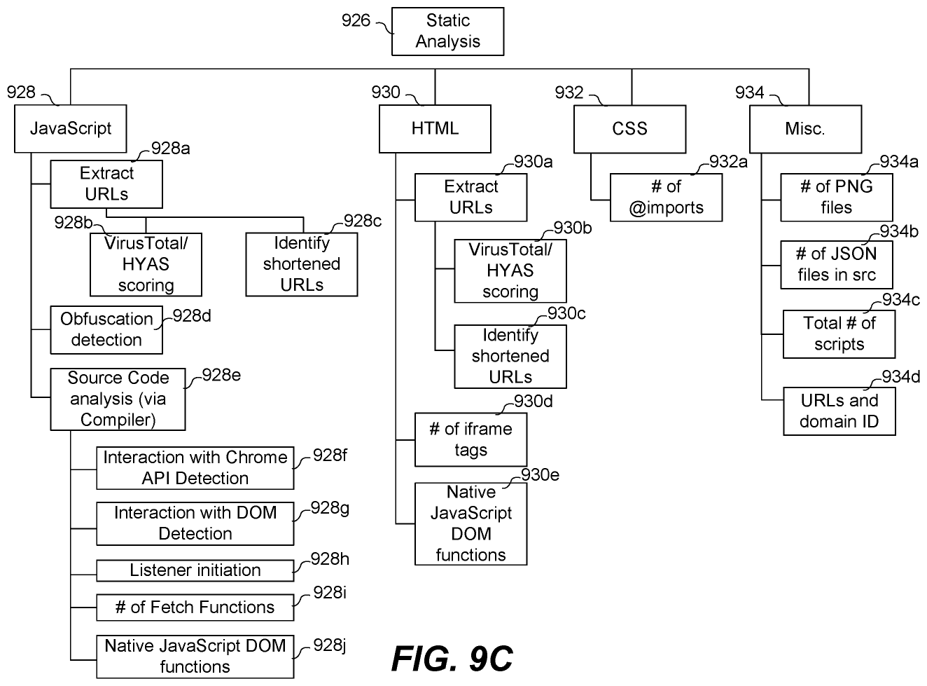

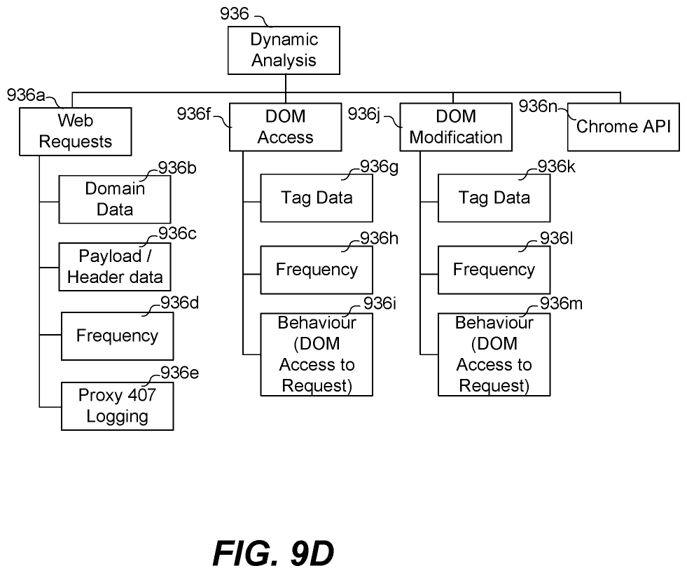

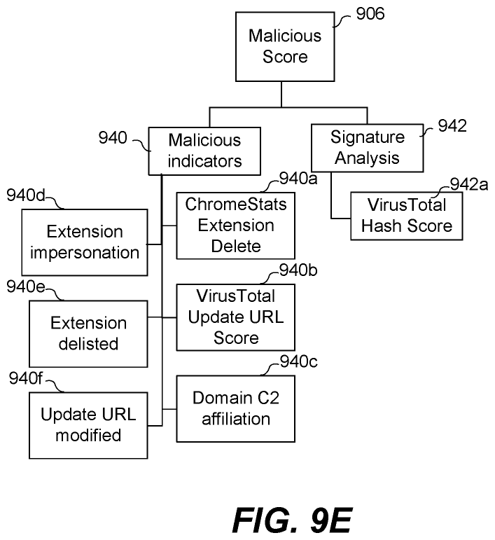

Based on the information and analysis of the web browser extension, a score is calculated for the web browser extension (660), which is used to predict whether the web browser extension is risky. Further details on an example scoring method are described with reference to FIGS. 9A-E. The score and all other associated information and analysis may be stored (670). Relevant features of the analysis may be aggregated (680), and/or a report of the analysis may be generated (682), and output to a relevant security team personnel (690), such as via an API.

FIGS. 7A and 7B respectively show an example of a method and representation of an architecture for performing dynamic analysis of a web browser extension. As described above, dynamic analysis analyzes the source code by running the web browser extension on a host machine to determine a behaviour of the web browser extension. Dynamic analysis thus differs from static analysis in that the dynamic analysis evaluates the execution of the code, which could identify risky behaviours not identified from the static analysis. For example, static analysis may reveal that the code is attempting to download a cookie, while dynamic analysis may reveal that the code downloads the cookie and then accesses a certain website. In some implementations, the dynamic analysis may be driven by the static analysis (e.g. the static analysis reveals the intent to download a cookie, so dynamic analysis is performed to understand what the cookie is attempting to do). In other words, in the static analysis a Chrome API call to access cookies/permissions to access cookies may be detected, but with dynamic analysis the event/code path can be triggered and telemetry on events following cookie access can be gathered, potentially detecting network traffic to a site.

In the method 700, an analysis environment is created for the web browser extension (in this case a Chrome/Edge extension) to run (702). Creating the analysis environment involves setting all the processes required to run the dynamic analysis, and includes fetching Chromium source code and adding a custom patch, fetching a Chrome/Edge extension to be analyzed and adding a custom patch, and creating Docker containers for executing the dynamic analysis. Note that the dynamic analysis can be modified appropriately for other browsers and browser extension types.

To be able to see the Chrome/Edge extension's activity while running the extension, it is necessary to have a deep look inside the browser and the extension. To do this, the Chromium project's source code is effectively cloned and a custom patch is applied inside Chromium, and the source code is compiled into a custom Chromium browser on a virtual machine. The patch is inserted into certain segments of the code, and when these segments get called on while running, the patch may be configured to send a HTTP request to a specific IP address with the information in that code block it resides in. These locations where the patch is applied are in key locations where the extension's activity can be monitored using a Chrome API to access functionality that the Chromium browser offers. After the patch is applied to the Chromium source code and the binaries are built, a testing infrastructure may be used to check the functioning of the browser with the inserted patch. The custom Chromium browser is thus configured to provide information on the extension's activities while running on the virtual machine, and has the ability to run both Edge and Chrome extensions.

The extension is modified with API hooks. The open-source project Jelly performs source code analysis and AST traversal. For modifying web browser extensions to perform dynamic analysis, this project was modified and enhanced. In particular, a feature was added to insert a function call of the extension's code in JavaScript. This function serves as an inside look into which part of the code would be executed at what time in the extension during the dynamic analysis. That is, coverage functions are added to the extensions before they are run during the dynamic analysis, providing information about the exact extension execution flow at what time and sequence, which is useful for understanding how reliable the dynamic analysis is. For example, it can be determined how much of the extension code has been executed, thus informing if further testing is required.

The execution of the dynamic analysis of web browser extension requires an isolated environment that can be replicated and reproduced frequently. Docker may be used to produce this environment, and via Docker orchestration, containers can be created to execute the dynamic analysis, extract the required information, and exit successfully. Docker containers are created for running the dynamic analysis using Docker Compose managed by a Python application. Through the Python application, the environment of running dynamic analysis, aggregating logs, and managing the Docker is accomplished. It will be appreciated however that Docker is not required, and that dynamic analysis can be developed with any virtual machine/containerization alternative, for example podman.

The modified browser extensions may be stored in Docker volumes, and are inserted and mounted to containers when they are to be executed on the modified Chromium browser. While running the modified browser extension in the modified browser as described above, user scenarios are executed to mimic behaviour of a typical user (704), for example accessing certain websites, browsing websites, logging into webmail, saving bookmarks, etc. Inside the Docker container may be another Python application that controls the modified browser and extension and executes the user scenarios.

Test logs from the environment in which the web browser extension is executed are collected and aggregated (706). Once the extension analysis has successfully exited, the application pulls the logs before the Docker Compose infrastructure is torn down and proceeding with a next extension. Multiple log sources are collected and processed for subsequent analysis, scoring and predictions. The log sources may include: Selenium-wire logs (the selenium-wire controls chromedriver to orchestrate chrome into doing desired actions, so these logs give insight into web requests made by chrome as well and all the logs for the chromedriver); Python application controlling Selenium logs (this is the Python application that spawns selenium-wire inside the Docker container, and typically provides extensive logging); Chromium API hooks (this gives insight into Chrome API usage and DOM manipulations); Extension hooks (this gives insight into what segment of the extension is being called and at what time); and/or Docker logs (this is used in the monitoring all of the application in the Docker container as well as data going through tcp-proxy). Docker, Python application, and Selenium-wire logs can be pulled via Docker CLI commands. The logs forwarded via hooks may be captured via a FastAPI server that is constantly running and capturing these logs. The logs may be pre-processed into proper formatting before storage in a database, such as in MongoDB.

The test logs are analyzed for use in scoring features of the dynamic analysis (708). Features are extracted from the logs and analyzed to determine web requests and API usage and/or to observe logs for abnormal and/or malicious behaviour. Further, baseline logs may be created by running the scenarios inside the container but without any extensions. The baseline logs provide an understanding of how the browser behaves without the presence of any extensions. Accordingly, a further analysis may be performed that compares the test logs against the baseline logs, and provides information about how the process deviated with the presence of the extension. An example scoring algorithm for scoring features from the dynamic analysis along with other features of a browser extension is described in more detail below with reference to FIGS. 9A-E.

FIG. 7B shows a high-level representation of the dynamic analysis architecture. A build machine 710 is used to apply the custom patches to Chromium and to deploy the Docker. The dynamic analysis application 720 creates and manages the Docker containers for the dynamic analysis. The Docker 730 is run on a host machine, and comprises the extension analysis container where the extension analysis is performed, and may comprise other containers such as a tcp-proxy container that may be used to capture logs from the extension analysis container. The Docker 730 may also comprise Docker images storing images used when performing dynamic analysis, and Docker Volumes used to store the Chromium executables and extension files to be executed. The logs from the dynamic analysis are ingested by a log ingestion component 740, which ingests/collects and stores the logs. Analysis engine 750 is used to analyze the stored logs, and the statistics/features from the analysis are passed to scoring engine 760.

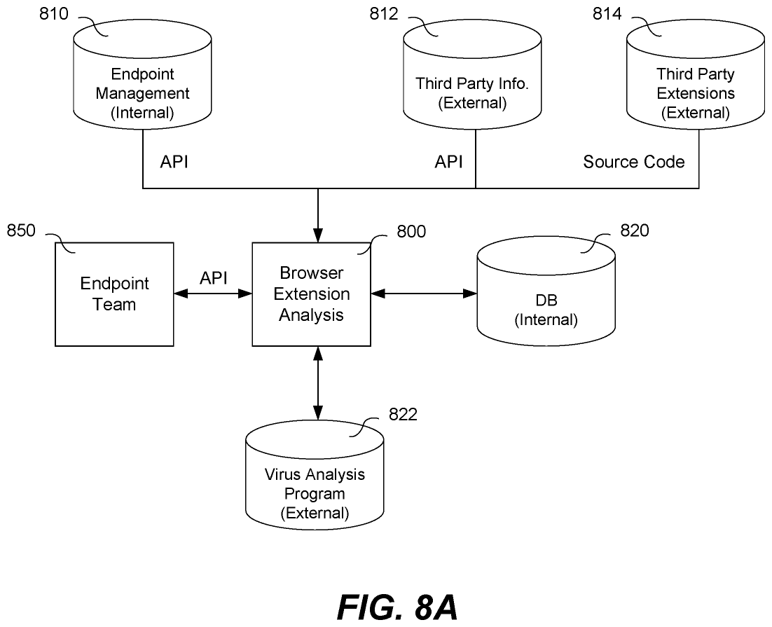

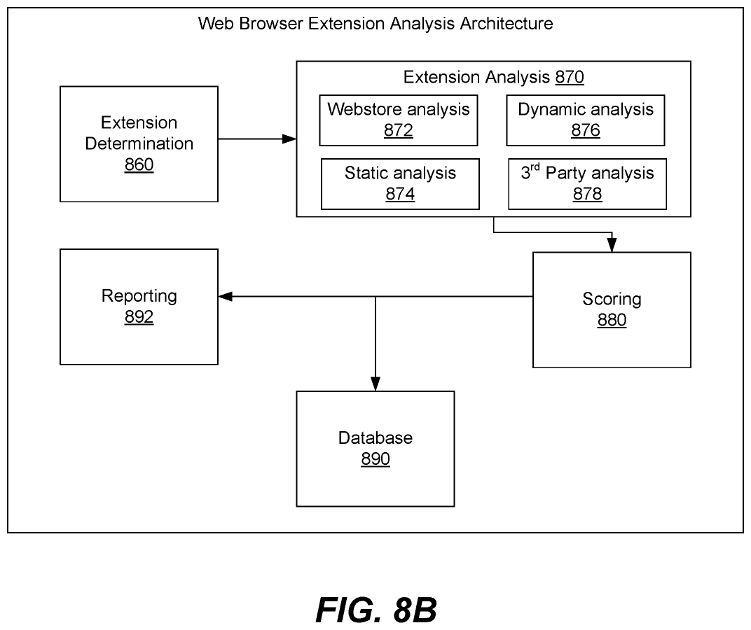

FIGS. 8A and 8B show example representations of an architecture for analyzing web browser extensions.

Referring to FIG. 8A, browser extension analysis script 800, running on a server such as server 108 in FIG. 1, is configured to interface with various applications to retrieve and send data via various API calls. For example, the browser extension analysis script 800 may obtain information on web browser extensions in use by devices within an organization from an internal endpoint management solution 810, such as Tanium. Further, the browser extension analysis script 800 may access browser extension information from third parties 812, such as accessing ChromeStats to obtain statistics on web browser extensions, CRXcavator to obtain a CRXcavator risk score for web browser extensions, etc. Web browser extension information, including source code, may be obtained from third party extension webstores 814, such as by accessing Google Extensions and/or Microsoft Extensions to obtain source code of web browser extensions, etc. The browser extension analysis script 800 is also configured to access an internal database 820, which can store data retrieved for the web browser extension and data produced during the analysis. The internal database may for example be a MongoDB database. The browser analysis script 800 may also run parts of the source code such as URLs through an external virus analysis program 822 such as VirusTotal, as described above. The browser extension analysis script 800 computes an indication of risk for the web browser extension, and outputs the indication of risk along with any other relevant information to an endpoint or security team (850).

FIG. 8B shows a representation of the web browser extension analysis architecture, such as with browser extension analysis script 800 in FIG. 8A.

Extension determination module 860 comprises processing for determining web browser extensions to be analyzed. For example, a query process may be used to identify web browser extensions operating on user devices (e.g. including user id, machine id, extension id, and version), and to compare the web browser extensions to previously analyzed web browser extensions to discover new extensions that require analysis. Also, extension determination module 860 may comprise an updater process, which fetches the latest Chrome API and DOM API methods and information, identifies if there are new or updated permissions not yet scored, and allows for scoring and descriptions of these new permissions, as well as modifying existing permission scoring.

Extension analysis module 870 is used to analyze web browser extensions. The extension analysis module 870 comprises a webstore analysis module 872 that accesses an appropriate webstore for the web browser extension (if applicable) and obtains desired features for performing extension analysis. The extension analysis module 870 also comprises a static analysis module 874 that extracts source code, analyzes the source code including performing manifest, JavaScript, and miscellaneous file analysis, as well as performs call graph analysis, as described with reference to FIG. 5. Extension analysis module 870 also comprises a dynamic analysis 876 for performing dynamic analysis, as described with reference to FIGS. 6, 7A, and 7B. The extension analysis module 870 may also comprise a 3^{rd} party analysis module 878 that uses 3^{rd} party applications such as HYAS, VirusTotal, etc. to look for malicious behaviour.

Data from the extension analysis module 870 is passed to scoring module 880, which generates an indication of risk for the web browser extension. The indication of risk and details of the analysis are stored in a database 890 and passed to reporting module 892 that prepares a report and notifies appropriate stakeholders.

FIGS. 9A-E show an example representation of scoring a risk posed by a web browser extension. The score for the web browser extension may be used to indicate a risk posed by the browser extension, and may be used to indicate whether the web browser extension should be allowed on the user device. An overall score may be based on one or more of: a reputation score (i.e. how popular and legitimate the extension is), as described with respect to FIG. 9A, a risk score (i.e. how risky is the extension), as described with reference to FIGS. 9B-9D, and a malicious score (i.e. how malicious is this extension), as described with reference to FIG. 9E. The overall score may thus be used to determine whether the extension should be allowed to operate on user devices, and use of the browser extension on user devices can be prevented when the browser extension is deemed risky. It will be appreciated that these scores may be combined in different weightings to generate the overall score for the web browser extension. A configuration file may be used to specify the weightings applied to the scoring to determine the overall score, as well as weightings and functions to be applied to the features calculated for determining each of the reputation, risk, and maliciousness scores. The weightings, functions, and scoring parameters can be defined in the configuration file, and it will be appreciated that different techniques to calculate the overall score (i.e. as an indication of risk) may be implemented without departing from the scope of this disclosure.

FIG. 9A shows variables that may be considered to generate a reputation score 902 for the browser extension, which may be used as part of generating an overall score. A description 910 of the browser extension, for example from the webstore, may be evaluated to analyze the description 910a and determine a language of the description 910b. Analyzing the description may comprise performing statistical analysis and NLP methods. A popularity 912 of the browser extension may be evaluated based on a number of computers within the organization using the browser extension 912a (the more machines using the extension, the more reputable it is), the total number of webstore downloads 912b (the more users are listed in the webstore as using it, the more reputable it is), and a number of reviews on the webstore 912c (if the number of reviews is higher, this likely means the package has a better reputation). The reviews 914 of the browser extensions may be evaluated using statistical analysis and NLP methods, and by determining a webstore rating 914a for the browser extension, as well as performing fake analysis reviews 914b, such as by analyzing the number of people with default profile pictures providing reviews, the last time a review was made, the similarity of the text in the reviews, and the similarity of the names of the review authors. The publisher 916 of the browser extension may be evaluated by determining whether the publisher is listed 916a and the publisher contact information is available 916b (if a publisher is listed this means that there is a better chance that the extension is reputable), including publisher address 916c, publisher email 916e, and evaluating if there is a publisher privacy disclosure 916d. Other miscellaneous information 918 may be evaluated, such as default locale 918a (i.e. the default language of an extension that supports multiple locales), extension update frequency 918b, if the browser extension is webstore verified 918c, whether the browser extension is featured in the webstore 918d (a featured extension is more likely to be reputable), whether there is a webstore hosting 918e (if an extension is on the webstore, this means that there is a better chance that the extension is benign), whether the browser extension is on a block list 918f (if it is, then it has already been flagged as malicious, and a reputation score of 0 may be returned), and by analyzing a category of the browser extension 918g. ChromeStats may also be accessed to determine reputation factors, such as ChromeStats size score (ChromeStats dubs a higher extension size as more reputable), ChromeStats update time score, whether the publisher is a ChromeStats trusted publisher (if a publisher has been identified as a trusted publisher, this increases the reputation of the extension). Different weightings may be applied to these different variables to generate the reputation score. For example, if the browser extension is on the blocklist (918f), a score of 0 may be applied at 100% weighting. Various functions/weightings may be applied to different variables as will be appreciated by a person skilled in the art. Further, only some of the variables described above may be used to generate the reputation score, and may depend on the availability of information, etc.

FIG. 9B shows variables that may be considered to generate a risk score 904 for the browser extension, which may be used as part of generating an overall score. Permissions 920 granted to the web browser extension may be evaluated, and risk scores may be assigned to each permission, thus providing for a determination of total permission scores 920a. Permissions allow the extension to read cookies, and interact with the end users data and webpages. By having open permission, it allows the extension to have more access to execute potentially unwanted behaviours, and thus poses a higher risk. Miscellaneous information 922 may be evaluated, and may comprise evaluating an extension file size 922a, an extension frequency update 922b, analyzing a category 922c, and identifying URL redirection and shorted URLs 922d. Further, a third party application such as CRXcavator or ChromeStats may be accessed to determine miscellaneous information from third party analysis, such as a CRXcavator content security policy (CSP) risk, CRXcavator dangerous functions, CRXcavator RetireJS vulnerabilities, ChomeStats privacy disclosure, ChromeStats risk score, and ChromeStats permission score. A high CSP score is indicative of risky behaviour due to the following: if an extension is communicating with many domains, there is an increased likelihood that other services have access to the information of the end-user; if an extension is communicating with risky/malicious domains (reflected in the CSP score) then there is an increased likelihood that information from the end-user is being used maliciously. Retire.JS risk score is used to identify old libraries used by an extension that have vulnerabilities, and is an indicator of risk because: (i) the extension has not been updated recently, and/or (ii) the extension is exploitable. Dangerous Functions show entry points and dangerous functions within the extension (i.e., methods an attacker could inject code into the extension), and may be risky due to the following: an attacker may be able to read information from the webpage that users visit. A higher risk score from ChromeStats increases the likelihood that an extension is risky. ChromeStats Privacy Disclosure is indicative of risk because no privacy disclosure may be risky and the extension may be collecting information that they don't want the end user to be aware of. A high permission score is risky because it may be indicative of an abuse of permissions.

Static analysis 926 may be performed, which as shown in FIG. 9C may comprise evaluating JavaScript files 928, HTML files 930, Cascading Style Sheet (CSS) files 932, and other miscellaneous information 934. To evaluate the JavaScript files 928, URLs may be extracted 928a and scored with VirusTotal/HYAS 928b, and shortened URLs may be identified 928c. Further, obfuscation detection 928d may be performed. Source code analysis 928e may be performed, which may comprise detecting interactions with Chrome API 928f, detecting interactions with Document Object Model (DOM) 928g, evaluating listener initiation 928h, evaluating a number of fetch functions 928i, evaluating native JavaScript DOM functions 928j, identifying high-risk clusters (not shown), and performing chain hunting (not shown). Call graph analysis may also be used, i.e., listener instantiation followed by Chrome API usage, followed by fetch. To evaluate the HTML files 930, URLs may be extracted 930a and scored with VirusTotal/HYAS 930b, and shortened URLs may be identified 930c. Further, a number of iframe tags 930d may evaluated, and native JavaScript DOM functions may be evaluated 930e. To evaluate the CSS files (932), the number of @imports may be evaluated 932a. Evaluating other miscellaneous information 934 may comprise evaluating a number of PNG files 934a, number of JSON files in src 934b, total number of scripts 934c, and URLs and domain identifiers 934d.

Dynamic analysis 936 may be performed, as shown in FIG. 9D. The dynamic analysis may comprise evaluating a number of web requests 936a, which may comprise evaluating domain data 936b, payload/header data 936c, frequency 936d, and proxy 407 logging 936e. The dynamic analysis may also comprise evaluating DOM access 936f, which may comprise evaluating tag data 936g, frequency 936h, and behaviour (DOM Access to Request) 936i. The dynamic analysis may also comprise evaluating DOM modification 936j, which may comprise evaluating tag data 936k, frequency 936l, and behaviour (DOM Access to Request) 936m. The dynamic analysis may also comprise evaluating Chrome API interactions 936n.

FIG. 9E shows variables that may be considered to generate a maliciousness score 906 for the browser extension, which may be used as part of generating an overall score. The maliciousness score may be generated by evaluating malicious indicators 940, which may comprise identifying whether the extension was deleted in ChromeStats 940a, and also by determining an update URL score from VirusTotal 940b. A deleted extension may be a malicious indicator because a malicious threat actor may try to upload a malicious extension for a short amount of time then remove it from the webstore in order to evade detection. The VirusTotal URL update score is generated if the update URL is not a webstore URL. The URL update score may be a malicious indicator because if an extension is benign it should not be updating from a known suspicious or malicious URL. Additionally, domain C2 affiliation may be determined 940c (i.e. whether a particular domain is known to be associated with command and control activity; command and control servers are servers controlled by threat actors to send commands to compromised systems), as well as extension impersonation 940d, whether the extension has been delisted from the webstore 940e, and if an update URL has been modified 940f. Further, signature analysis 942 may be evaluated, by determining a hash score from VirusTotal 942a. If an extension's hash is marked as malicious or suspicious, then it is clearly a known bad extension.

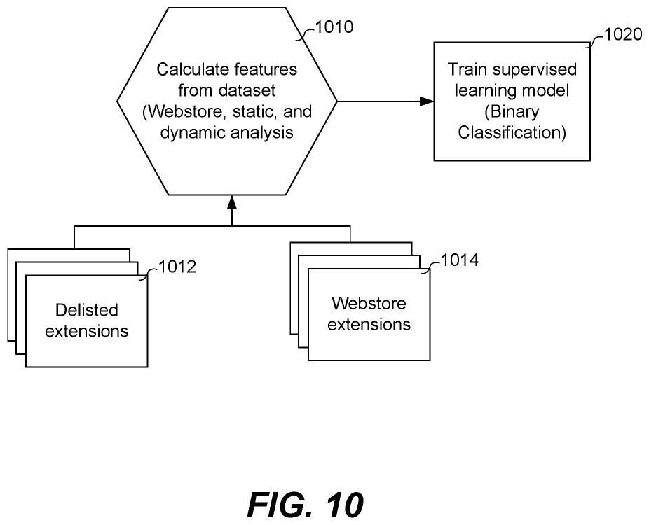

FIG. 10 shows a representation of using machine learning in the scoring algorithm. A binary classification task may be used to optimize the scoring of web browser extensions. A labeled dataset can be made (1010) using features from a combination of webstore extensions 1014 (i.e. extensions available to be downloaded) and delisted extensions 1012 (i.e. extensions that have been blocked for use by user devices). The labeled dataset can be used to train a supervised learning model 1020 that performs binary classification of either (a) allowed on user devices, or (b) risky extension and not allowed on user devices. Accordingly, the machine learning model can be trained to classify extensions as risky or not by learning which features are contained in malicious extensions.

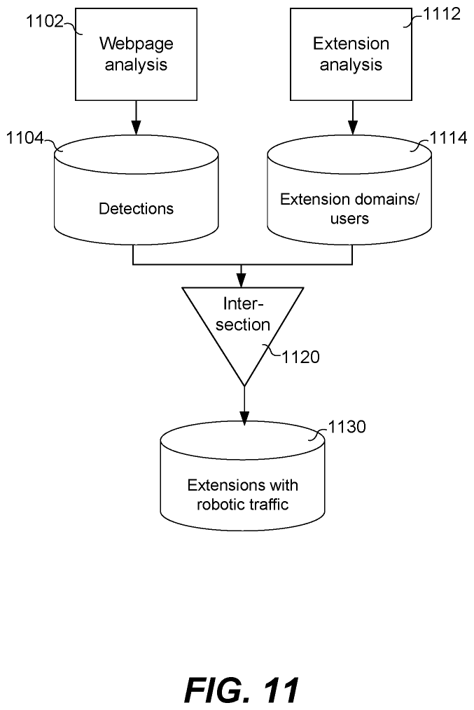

FIG. 11 shows a representation of associating browser extensions with robotic activity. As discussed above, URLs are extracted during the static analysis of the source code and evaluated for malicious or risky behaviour, and may be deemed risky if they are associated with robotic network activity.

As shown in FIG. 11, extension analysis 1112 identifies extension domains/users 1114, and a webpage analysis 1102 identifies webpages associated with robotic activity stored as detections 1104. The intersection 1120 of these databases can thus identify extensions associated with robotic traffic 1130, which would increase a risk posed by the browser extension calling on those URLs.

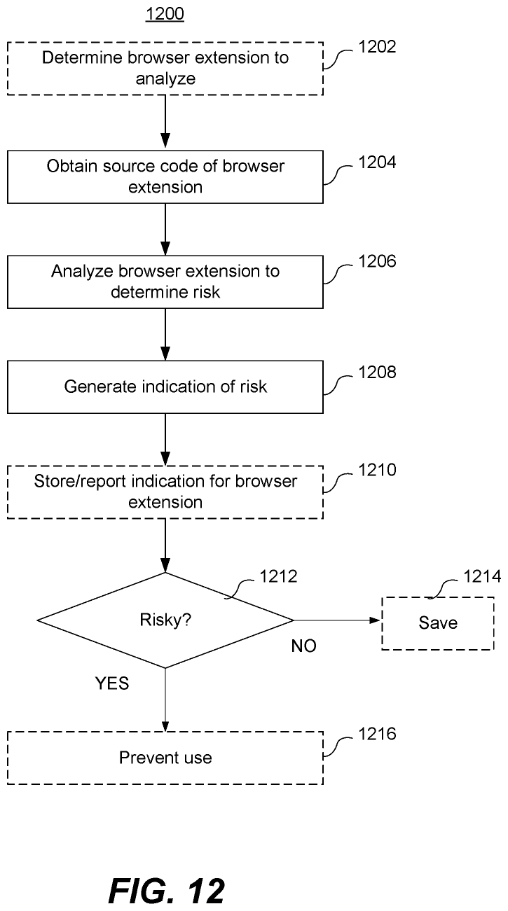

FIG. 12 shows an exemplary method 1200 of analyzing a web browser extension. The method 1200 may be performed by the one or more servers 108 shown in FIG. 1.

The method 1200 may comprise determining a browser extension to be analyzed (1202). For example, one or more browser extensions operating on a computing device may be determined, a determination may be made as to whether each of the one or more browser extensions have not been analyzed, and the browser extension to be analyzed can be determined as a browser extension of the one or more browser extensions that have not been analyzed. The system may communicate with one or more user devices to determine web browser extensions operating thereon, and to determine the web browser extension to be analyzed from the web browser extensions operating on the one or more user devices. Note however that instead of determining the browser extension to be analyzed, information of the browser extension to be analyzed may be previously determined and passed as inputs for executing the analysis.

Source code of the browser extension is obtained (1204). For example, an indication of a browser extension to be analyzed may be provided as an input for executing the analysis, and/or the indication of the browser extension may be determined by identifying/determining the browser extension to be analyzed. The indication of the browser extension to be analyzed may comprise a browser extension identifier and version number. The identifier and version number of the browser extension can be used to access a webstore page to retrieve the source code of the browser extension, along with other relevant information. Alternatively, custom browser extensions may not have a webstore page, and accordingly the source code may be obtained directly from the developer or user device.

The browser extension is analyzed to determine a risk posed by the browser extension (1206). Specifically, the source code of the browser extensions is analyzed. For example, analyzing the source code of the web browser extension may comprise determining one or more permissions granted by the browser extension, and assigning a risk category to each of the one or more permissions. Assigning the risk category to each of the one or more permissions may comprise accessing a database storing information comprising risk categories defined for each permission available to be granted by a given browser extension. Additionally or alternatively, analyzing the source code of the web browser extension may comprise analyzing the source code to identify one or more known risky behaviours. Known risky behaviours may comprise any one or more of: accessing a malicious webpage, making changes to DOM, making Browser API calls to gather certain information, making suspicious network requests, and/or making phishing requests. Additionally or alternatively, analyzing the source code of the web browser extension may comprise analyzing the source code to detect obfuscation. Additionally or alternatively, analyzing the source code of the web browser extension may comprise extracting one or more URLs from the source code, and determining whether each of the one or more URLs are malicious by comparing each of the one or more URLs to known malicious webpages. A determination may also be made as to whether each of the one or more URLs are associated with robotic network activity. Additionally or alternatively, analyzing the source code of the web browser extension may comprise generating a call graph from the source code and analyzing the call graph to identify suspicious behaviours.

Analyzing the source code of the web browser extension may additionally or alternatively comprise performing a dynamic analysis of the source code by running the web browser extension on a host machine to determine a behaviour of the web browser extension. Performing the dynamic analysis may comprise executing user scenarios on the virtual machine while the web browser extension is running, and collecting test logs from one or more sources for analysis. Performing the dynamic analysis may also comprise creating baseline logs by executing the user scenarios on the virtual machine without running the web browser extension, and wherein the test logs are compared to the baseline logs in the analysis.

The analysis of the source code may be used to generate a risk score for the web browser extension. Analyzing the browser extension may also comprise determining one or more other evaluations/scores, such as a reputation score and/or a maliciousness score. For example, analyzing the browser extension may comprise obtaining reputability information associated with the web browser extension, such browser extension information being obtained from a webstore page for the browser extension. Analyzing the browser extension may also comprise comparing the browser extension to a list of known malicious browser extensions,

An indication of a risk posed by the browser extension is generated (1208). The indication of the risk posed by the browser extension allows for use in determining whether to allow or block the browser extension. The indication of the risk may be an overall score calculated based on the risk score and one or more other scores. The indication of the risk may additionally or alternatively be a category of risk, such as negligible, low, medium, high, critical, etc.

The browser extension information and the indication of the risk of the risk posed by the browser extension may be stored, and a report may be generated for the analysis of the web browser extension including the indication of risk posed by the web browser extension (1210). A determination is made whether the browser extension is deemed risky (1212), based on the indication of the risk posed by the browser extension. The determination may be made automatically by the computer program, and/or may be require manual input that deems the browser extension risky based on the indication of the risk. If the browser extension is not deemed risky (NO at 1212), the analysis of the browser extension is saved (1214) and use of the browser extension on user device(s) remains available. If the browser extension is deemed risky (YES at 1212), use of the browser extension on user device(s) may be prevented (1216). Preventing use of the browser extension may for example be implemented for all user devices across an organization.

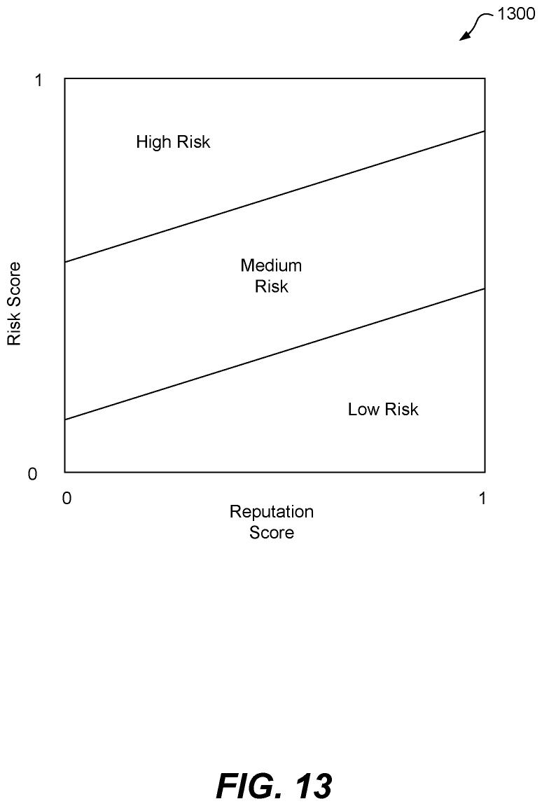

FIG. 13 shows an example graph 1300 of risk thresholds based on the indication of risk calculated from analysis of a web browser extension. In some embodiments, an overall score may be a linear combination of the reputation score and the risk score at specified weightings, and the malicious score offsets the overall score. In some embodiments, non-linear scoring functionality may be used to calculate the risk score and the reputation score, and returns a value between 0 and 1. The malicious score may be a binary value that is 0 or 1. The graph 1300 shows example thresholds for deeming a web browser extension to be low, medium, or high risk.

The processor used in the foregoing embodiments may comprise, for example, a processing unit (such as a processor, microprocessor, or programmable logic controller) or a microcontroller (which comprises both a processing unit and a non-transitory computer readable medium). Examples of computer readable media that are non-transitory include disc-based media such as CD-ROMs and DVDs, magnetic media such as hard drives and other forms of magnetic disk storage, semiconductor based media such as flash media, random access memory (including DRAM and SRAM), and read only memory. As an alternative to an implementation that relies on processor-executed computer program code, a hardware-based implementation may be used. For example, an application-specific integrated circuit (ASIC), field programmable gate array (FPGA), system-on-a-chip (SoC), or other suitable type of hardware implementation may be used as an alternative to or to supplement an implementation that relies primarily on a processor executing computer program code stored on a computer medium.

The embodiments have been described above with reference to flow, sequence, and block diagrams of methods, apparatuses, systems, and computer program products. In this regard, the depicted flow, sequence, and block diagrams illustrate the architecture, functionality, and operation of implementations of various embodiments. For instance, each block of the flow and block diagrams and operation in the sequence diagrams may represent a module, segment, or portion of code, which comprises one or more executable instructions for implementing the specified action(s). In some alternative embodiments, the action(s) noted in that block or operation may occur out of the order noted in those figures. For example, two blocks or operations shown in succession may, in some embodiments, be executed substantially concurrently, or the blocks or operations may sometimes be executed in the reverse order, depending upon the functionality involved. Some specific examples of the foregoing have been noted above but those noted examples are not necessarily the only examples. Each block of the flow and block diagrams and operation of the sequence diagrams, and combinations of those blocks and operations, may be implemented by special purpose hardware-based systems that perform the specified functions or acts, or combinations of special purpose hardware and computer instructions.

The terminology used herein is for the purpose of describing particular embodiments only and is not intended to be limiting. Accordingly, as used herein, the singular forms “a”, “an”, and “the” are intended to include the plural forms as well, unless the context clearly indicates otherwise (e.g., a reference in the claims to “a challenge” or “the challenge” does not exclude embodiments in which multiple challenges are used). It will be further understood that the terms “comprises” and “comprising”, when used in this specification, specify the presence of one or more stated features, integers, steps, operations, elements, and components, but do not preclude the presence or addition of one or more other features, integers, steps, operations, elements, components, and groups. Directional terms such as “top”, “bottom”, “upwards”, “downwards”, “vertically”, and “laterally” are used in the following description for the purpose of providing relative reference only, and are not intended to suggest any limitations on how any article is to be positioned during use, or to be mounted in an assembly or relative to an environment. Additionally, the term “connect” and variants of it such as “connected”, “connects”, and “connecting” as used in this description are intended to include indirect and direct connections unless otherwise indicated. For example, if a first device is connected to a second device, that coupling may be through a direct connection or through an indirect connection via other devices and connections. Similarly, if the first device is communicatively connected to the second device, communication may be through a direct connection or through an indirect connection via other devices and connections. The term “and/or” as used herein in conjunction with a list means any one or more items from that list. For example, “A, B, and/or C” means “any one or more of A, B, and C”.

It is contemplated that any part of any aspect or embodiment discussed in this specification can be implemented or combined with any part of any other aspect or embodiment discussed in this specification.

The scope of the claims should not be limited by the embodiments set forth in the above examples, but should be given the broadest interpretation consistent with the description as a whole.

It should be recognized that features and aspects of the various examples provided above can be combined into further examples that also fall within the scope of the present disclosure. In addition, the figures are not to scale and may have size and shape exaggerated for illustrative purposes.

1. A method of analyzing a web browser extension, comprising:
obtaining source code of the web browser extension;
analyzing the source code to determine a risk posed by the web browser extension; and
generating an indication of risk posed by the web browser extension based on the analysis of the source code.

2. The method of claim 1, wherein analyzing the source code of the web browser extension comprises:
determining one or more permissions granted by the web browser extension; and
assigning a risk category to each of the one or more permissions.

3. The method of claim 1, wherein analyzing the source code of the web browser extension comprises analyzing the source code to identify one or more known risky behaviours.

4. The method of claim 3, wherein the known risky behaviours comprise any one or more of:
accessing a malicious webpage, making changes to a document object model, making browser application programming interface calls to gather information, making suspicious network requests, and making phishing requests.

5. The method of claim 1, wherein analyzing the source code of the web browser extension comprises analyzing the source code to detect obfuscation in the source code.

6. The method of claim 1, wherein analyzing the source code of the web browser extension comprises:
extracting one or more URLs from the source code; and
determining whether each of the one or more URLs are malicious by comparing each of the one or more URLs to known malicious webpages.

7. The method of claim 6, further comprising:
determining whether each of the one or more URLs are associated with robotic network activity.

8. The method of claim 1, wherein analyzing the source code of the web browser extension comprises generating a call graph from the source code and analyzing the call graph to identify suspicious behaviours.

9. The method of claim 1, wherein analyzing the source code of the web browser extension comprises performing a dynamic analysis of the source code by running the web browser extension on a host machine to determine a behaviour of the web browser extension.

10. The method of claim 9, wherein performing the dynamic analysis comprises executing user scenarios on the host machine while the web browser extension is running, and collecting test logs from one or more sources for analysis.

11. The method of claim 10, further comprising creating baseline logs by executing the user scenarios on the host machine without running the web browser extension, and wherein the test logs are compared to the baseline logs in the dynamic analysis.

12. The method of claim 1, wherein obtaining the source code of the web browser extension comprises:
receiving an identifier of the web browser extension; and
obtaining the source code from a webstore page using the identifier of the web browser extension.

13. The method of claim 1, further comprising obtaining reputability information associated with the web browser extension, and wherein generating the indication of risk posed by the web browser extension is further based on the reputability information.

14. The method of claim 13, wherein the reputability information associated with the web browser extension information is obtained from a webstore page for the web browser extension.

15. The method of claim 1, further comprising comparing the browser extension to a list of known malicious browser extensions, and wherein generating the indication of risk posed by the web browser extension is further based on the comparison.

16. The method of claim 1, further comprising storing results of the analysis of the source code of the web browser extension and the indication of risk posed by the web browser extension.

17. The method of claim 1, wherein analyzing the source code of the web browser extension comprises performing a static analysis of the source code and performing a dynamic analysis of the source code by running the web browser extension on a host machine.

18. A system, comprising:
a processor; and
a non-transitory computer-readable medium having computer-executable instructions stored thereon, which when executed by the processor configure the system to:
obtain source code of a web browser extension to be analyzed;
analyze the source code to determine a risk posed by the web browser extension; and
generate an indication of risk posed by the web browser extension based on the analysis of the source code.

19. The system of claim 18, wherein the system is further configured to communicate with one or more user devices to determine web browser extensions operating thereon, and to determine the web browser extension to be analyzed from the web browser extensions operating on the one or more user devices.

20. A non-transitory computer-readable medium having computer-executable instructions stored thereon, which when executed by a processor configure the processor to perform a method of analyzing a web browser extension comprising:
obtaining source code of the web browser extension;
analyzing the source code to determine a risk posed by the web browser extension; and
generating an indication of risk posed by the web browser extension based on the analysis of the source code.
